(19) United States
(12) Patent Application Publication
(10) Pub. No.: US 2011/0246114 A1
(43) Pub. Date: Oct. 6, 2011

(54) METHOD AND APPARATUS FOR CALIBRATING A FALL DETECTOR

(75) Inventor: Sheng Jin, Shanghai (CN)

(73) Assignee: KONINKLIJKE PHILIPS ELECTRONICS N.V., EINDHOVEN (NL)

(21) Appl. No.: 13/139,578

(22) PCT Filed: Dec. 4, 2009
(86) PCT No.: PCT/IB09/55495

§ 371 Date: Jun. 14, 2011

(30) Foreign Application Priority Data
Dec. 15, 2008 (CN) 200810183742.7

(51) Int. Cl. G08B 21/04

(52) U.S. Cl. 702/94

(57) ABSTRACT

This invention relates to a method and apparatus for calibrating a fall detector, a method of setting a fall detector, and a fall detector. According to the invention, the method of calibrating a fall detector comprises (a) acquiring the duration of a free fall of the fall detector; (b) calculating the change in height of the fall detector during the free fall from said duration; (c) measuring the change in height of the free fall by the fall detector; (d) calculating the difference between the calculated change in height and the measured change in height; and (e) updating a threshold in the fall detector for determining whether or not a fall has occurred on the basis of this difference.

### FIELD OF THE INVENTION

The invention relates to fall detection, particularly to a method and apparatus for calibrating a fall detector, a method for setting a fall detector, and a fall detector.

### BACKGROUND OF THE INVENTION

EP 1 642 248 describes a wearable multi-modality fall detector which uses both an accelerometer and a barometer to increase the reliability of fall detection (see the disclosure of patent document EP 1 642 248, the contents of which are incorporated herein by reference). It is possible to derive the altitude change of the fall detector during a fall from the air pressure measured by the barometer. Usually the altitude of the fall detector will decrease by at least 50 cm if it is worn on the upper part of the body, which decrease can be captured by the barometer.

However, the altitude sensor (such as the barometer) used in the fall detector and measuring a change in air pressure is quite sensitive and can be easily affected by different ambient factors such as temperature and absolute altitude, resulting in a low reliability of the fall detector.

In conventional fall detectors the threshold of the height change used for determining whether a fall occurs is set as a fixed value for all users, e.g. 0.5 m. However, the heights of different users are normally different, which introduces additional errors in the fall detection.

### SUMMARY OF THE INVENTION

An object of the invention is to provide a method of calibrating a fall detector so as to improve the reliability of the fall detector.

According to one aspect of the present invention, it provides a method of calibrating a fall detector, comprising:
(a) acquiring the duration of a free fall of the fall detector;
(b) calculating the change in height of the fall detector during the free fall based on the duration;
(c) measuring the change in height of the free fall by the fall detector;
(d) calculating the difference between the calculated change in height and the measured change in height; and
(e) updating a threshold in the fall detector for determining whether or not a fall occurs on the basis of said difference.

By taking advantage of a free fall of the fall detector, the difference between the calculated change in height resulting from a free fall and the measured change in height during a free fall of the fall detector (obtained from the altitude sensor included in the fall detector) can be calculated and used as a parameter to compensate any errors of the fall detector. The invention thus provides a method of removing the errors of the fall detector caused by ambient factors, resulting in an improved fall detection reliability.

In another embodiment, the method further comprises: a step of repeating steps (a) to (d) to obtain an averaged difference for use by step (e).

In this way, a statistic processing is carried out for the differences between the calculated change in height and the measured change in height, and an averaged difference thereof is used for updating the threshold, whereby the reliability of the fall detection is further improved.

According to another aspect of the present invention, it provides an apparatus for calibrating a fall detector, comprising:
a first acquiring unit configured to acquire the duration of a free fall of the fall detector;
a first calculator configured to calculate the change in height of the fall detector during the free fall on the basis of said duration;
a second calculator configured to calculate the difference between the calculated change in height and the change in height of the free fall measured by the fall detector; and
an updating unit configured to update a threshold in the fall detector for determining whether or not a fall has occurred on the basis of said difference.

According to a further another aspect of the present invention, it provides a method of setting a fall detector, comprising:
acquiring the duration of a free fall of the fall detector taking place at the height where a user intends to wear the fall detector;
calculating the change in height of the fall detector during the free fall on the basis of said duration; and
setting the threshold in the fall detector for determining whether or not a fall has occurred on the basis of the calculated change in height.

By taking advantage of a free fall of the fall detector, this invention renders possible an automatic setting of the threshold for the fall detection algorithm in the fall detector and an adaptation of the threshold to users of different heights. Compared with the manual input method of the threshold, the proposed method does not require any user interaction in setting the threshold and thus removes the need for any input device.

Other objects and results of the present invention will become more apparent and will be easily understood with reference to the description made in combination with the accompanying drawings.

### DESCRIPTION OF THE DRAWINGS

The present invention will be described and explained hereinafter in more detail in combination with embodiments and with reference to the drawings, wherein:

FIG. 1 shows signal readings of an accelerometer in a free fall procedure;

FIG. 2 is a flowchart of the method of calibrating a fall detector in accordance with the present invention;

FIG. 3 is a schematic block diagram of the apparatus for calibrating a fall detector in accordance with the present invention;

FIG. 4 is a flowchart of the method of setting a fall detector in accordance with the present invention; and

FIG. 5 is a schematic block diagram of the apparatus for setting a fall detector in accordance with the present invention.

The same reference signs in the figures indicate similar or corresponding features and/or functions.

### DETAILED DESCRIPTION

An embodiment of the present invention will be described hereinafter in more detail with reference to the drawings.

The invention is based on the recognition that, by measuring the time of a free fall of the fall detector, the altitude change can be calculated by the Free Fall Formula that can be taken as a standard measurement of the change in height for calibrating a fall detector, whose sensor readings may include errors caused by ambient conditions or other external factors.

FIG. 1 shows signal readings of an accelerator in a free fall procedure.

As is shown in FIG. 1, when the installer is holding the fall detector stationary in his hand, the earth's gravity exerts one G (9.8 m/s²) of downward force on the fall detector. When the fall detector is released, it will accelerate towards the floor at one G. In this “free-fall” case, each axis (up/down, left/right, front/back, X/Y/Z) of the triple-axis accelerator is at zero G up to the point of impact, at which time the g's experienced by the object become quite large, representing the fall detector impacting the ground. The complete signal readings of such a free fall procedure are plotted in FIG. 1.

Based on the above, the starting time ST and the ending time ET of a free fall can be easily confirmed from the number of samples during this period and the sampling rate, or directly by an internal timer. The change in height can be calculated as

H_{c}=1/2gt², where t is the duration of the free fall and g=1G=9.8 m/s².

At the same time, the change in height can be measured by the altitude sensor. By comparing the measured change in height Hₘ and the calculated H_{c}, an appropriate parameter for calibrating the altitude sensor can be obtained from P_{adjust}=H_{c}−Hₘ.

The fall detector will automatically write the parameter into an embedded ROM/RAM for future usage. For a next altitude measurement, the change in height measured by the altitude sensor before and after a fall will be calibrated with the parameter for getting a more reliable value.

The invention is based on the above recognition.

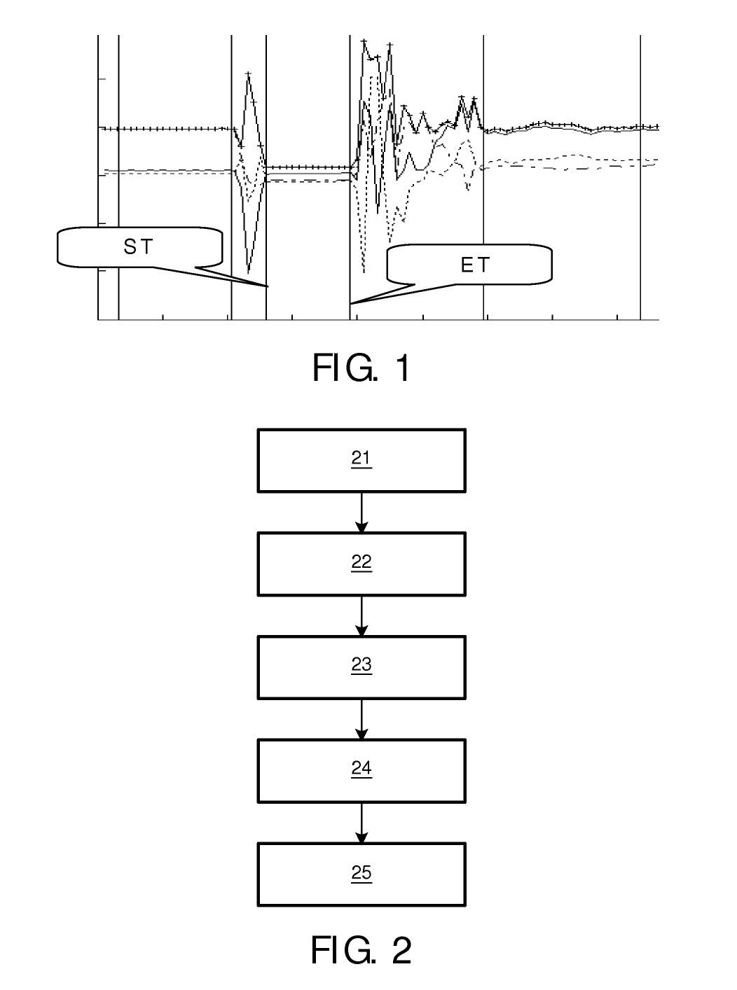

FIG. 2 is a flowchart of the method of calibrating a fall detector in accordance with the present invention.

As is shown in FIG. 2, the method of calibrating a fall detector comprises a step 21 of acquiring the duration of a free fall of the fall detector.

As was described above for an embodiment of the invention, the duration of a free fall of the fall detector may be acquired by the accelerometer in the fall detector. However, the present invention is not limited thereto, the duration may be acquired by an internal timer, an external timer, or any other means known in the art.

The method further comprises a step 22 of calculating the change in height of the fall detector during the free fall from this duration. As was described above, the change in height is given by H_{c}1/2gt², where t is the duration of the free fall and g=1G=9.8 m/s².

The method further comprises a step 23 wherein the change in height of the free fall is measured by the fall detector. The change in height is measured by the altitude sensor comprised in the fall detector in this case.

The method further comprises a step 24 of calculating the difference between the calculated change in height H_{c} and the measured change in height Hₘ.

The method further comprises a step 25 of updating a threshold in the fall detector for determining whether or not a fall has occurred on the basis of said difference.

There can be two ways of carrying out the calibration. In an embodiment of the invention, a threshold in the fall detector for determining whether or not a fall has occurred is updated on the basis of said difference. In another embodiment of the invention, the change in height measured by the altitude sensor in the fall detection is calibrated with the difference and then the calibrated change in height is compared with a fixed threshold in order to determine whether a fall has occurred.

By taking advantage of a free fall of the fall detector, the difference between the change in height calculated for a free fall and the measured change in height during a free fall of the fall detector (obtained from the altitude sensor included in the fall detector) can be calculated and used as a parameter to compensate any errors of the fall detector. The invention thus provides a method of removing the errors of the fall detector caused by ambient factors, resulting in an improved reliability of the fall detection.

For a small number of altitude change, the sensor readings may be regarded as linear. The real value of the change in height will be Hₘ+P_{adjust} then. If the mechanism behind the altitude sensor is non-linear, the compensating formula may still be assumed to be piecewise linear, and the free fall may be performed at different positions several times in order to get several calibration points. An averaged difference may be obtained, for example, by performing the free fall several times so as to obtain a more precise calibration value.

In this way a statistical processing is carried out for the differences between the calculated change in height and the measured change in height, and an averaged difference thereof is used for updating the threshold, whereby the reliability of the fall detection is further improved.

As was stated above, the altitude sensor used in the fall detector is based on measuring changes in air pressure, which is quite sensitive and can be easily affected by differences in the environment such as temperature and absolute altitude. In view of this, when there is a major change in the environment of the user wearing the fall detector, for example if the weather of the region where the user is present changes greatly or the user travels from his home to a tourism site where the weather is quite different from the previous one, it will be necessary to calibrate the fall detector.

Therefore, in normal use of the fall detector, the method further comprises a step of acquiring weather parameters reflecting the current environmental situation. As is well known, the weather parameters may comprise, but are not limited to, air pressure, temperature, humidity, wind power, wind speed, and more.

Furthermore, the method comprises a step of comparing the acquired parameters with weather parameters stored in advance in the fall detector to determine whether there is a change in the environment that is out of the predefined scope, the stored weather parameters reflecting the environmental conditions under which a previous calibration of the fall detector was carried out.

The method further comprises a step of generating a request for calibrating the fall detector if the result of the comparison indicates that a change of environment is out of the predefined scope.

When this method detects that there is a change in the environment that is out of the predefined scope, a request will be generated and the fall detector will be calibrated automatically to ensure a proper operation.

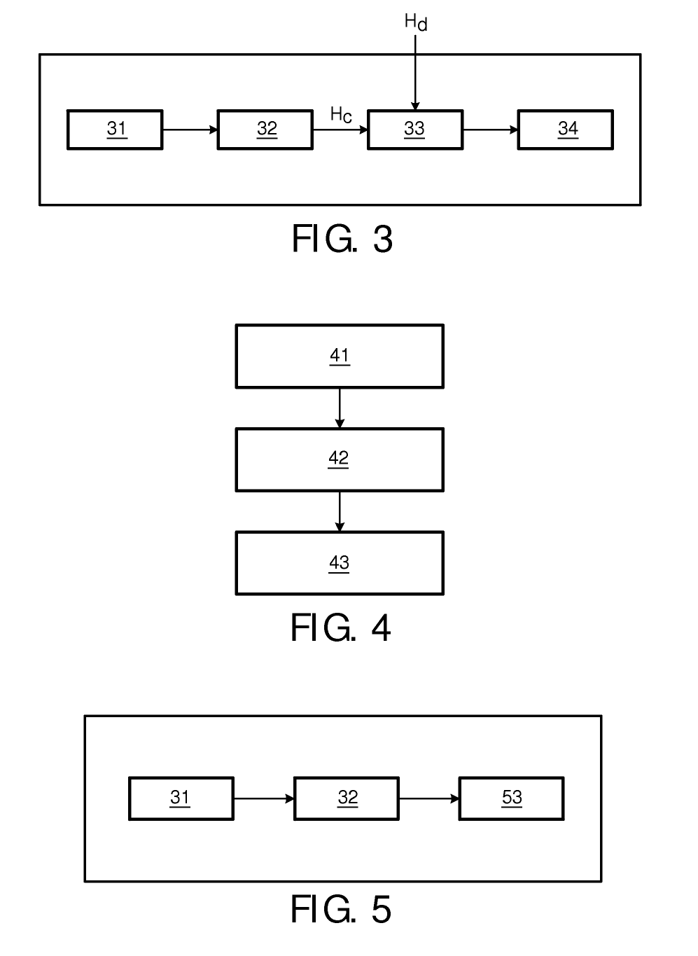

FIG. 3 is a schematic block diagram of the apparatus for calibrating a fall detector in accordance with the present invention.

The apparatus comprises a first acquiring unit 31 configured to acquire the duration of a free fall of the fall detector. The unit 31 can execute the step 21 described above.

The apparatus further comprises a first calculator 32 configured to calculate from said duration the change in height of the fall detector during the free fall. The unit 32 can execute the step 22 described above.

The apparatus further comprises a second calculator 33 configured to calculate the difference between the calculated change in height H_{c} and the change in height Hₘ of the free fall measured by the fall detector. The change in height Hₘ of the free fall is measured by the altitude sensor comprised in the fall detector and is inputted into the apparatus. The unit 33 can execute the step 24 described above.

The apparatus further comprises an updating unit 34 configured to update a threshold in the fall detector for determining whether or not a fall has occurred on the basis of said difference. The updating unit 34 can execute the step 25 described above.

In another embodiment of the invention, the apparatus for calibrating a fall detector further comprises a memory configured to store an averaged difference obtained by averaging the differences calculated several times by the unit 33 for calculating the difference, wherein the updating unit 34 updates the threshold with the averaged difference.

In yet another embodiment of the invention, the apparatus for calibrating a fall detector further comprises a second acquiring unit configured to acquire weather parameters reflecting a current environmental situation; a determining unit configured to compare the acquired parameters with weather parameters stored in advance in the fall detector to determine whether there is a change in the environment that is out of the predefined scope, the stored weather parameters reflecting the environmental conditions under which a previous calibration of the fall detector was carried out; and a unit for generating a request for calibrating the fall detector if the result of the comparison indicates that the change of environment is out of the predefined scope.

This invention further proposes that free-fall motion be utilized for automatically setting the height change threshold for the fall detection algorithm that can be adapted to users of different heights.

FIG. 4 is a flowchart of the method of setting a fall detector in accordance with the present invention.

As is shown in FIG. 4, the method of setting a fall detector comprises a step 41 of acquiring the duration of a free fall of the fall detector from a height at which a user intends to wear the fall detector. For example, if the user intends to wear the fall detector on his neck or on his wrist, the fall detector will be positioned at the height of the user's neck or wrist to carry out the free fall. The free fall may be done by an installer when the fall detection system is installed for the first time in a user's home.

As in the method of calibrating a fall detector, the duration of a free fall of the fall detector may be acquired by the accelerometer in the fall detector. However, the present invention is not limited thereto, the duration may alternatively be acquired by an internal timer, an external timer, or any other means known in the art.

The method further comprises a step 42 of calculating from the duration the change in height of the fall detector during the free fall. Since the step 42 is similar to the step 22 described above, the description thereof is omitted.

The method further comprises a step 43 of setting the threshold in the fall detector for determining whether or not a fall has occurred on the bias of the calculated change in height.

Conventionally, the threshold is smaller than the calculated change in height and the threshold may be a result obtained by multiplying the calculated change in height by a factor which, for example, may be 0.6. However, the present invention is not limited thereto, the factor used may be selected in accordance with the user's requirements.

The threshold in the fall detection algorithm can be automatically set and adapted to users of different heights by this method. Compared with the method of manually inputting the threshold, the proposed method does not require any user interaction or input device such as a keyboard.

Since the threshold used for determining whether or not a fall has occurred is associated with the body posture of the user immediately before the user starts to fall in practice, the method of setting a fall detector further comprises a step of determining the body posture of the user of the fall detector and a step of setting the threshold based on the body posture. Conventionally, it is of practical benefit to set the threshold for determining whether a fall of the user has occurred from a standing posture and the threshold for determining whether a fall of the user has occurred from a sitting posture, respectively.

FIG. 5 is a schematic block diagram of the apparatus for setting a fall detector in accordance with the present invention.

The apparatus comprises units 31-32 that are similar to the units described with reference to FIG. 3. The apparatus further comprises a setting unit 53 configured to set the threshold in the fall detector for determining whether or not a fall has occurred on the basis of the calculated change in height. The setting unit 53 is capable of executing the step 43 described above.

In an embodiment of the invention, the apparatus for calibrating a fall detector and the apparatus for setting a fall detector are described as separate from the fall detector. However, the apparatus for calibrating or setting a fall detector may be integral with the fall detector. In this case, the first acquiring unit 31 for acquiring the duration of a free fall of the fall detector may be the accelerometer or an internal timer in the fall detector.

The invention may be implemented by means of hardware comprising several distinct elements, and by means of a suitable computer program. In the device claim enumerating several means, several of these means may be embodied by one and the same item of hardware. The mere fact that certain measures are recited in mutually different dependent claims does not indicate that a combination of these measures cannot be used to advantage.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the apparatus claims enumerating several units, several of these units can be embodied by one and the same item of software and/or hardware. The usage of the words first, second and third, et cetera, does not indicate any sequential ordering. These words are to be interpreted as names.

1. A method of calibrating a fall detector, comprising the steps of:
(a) acquiring (21) duration of a free fall of the fall detector;
(b) calculating (22) from said duration a change in height of the fall detector during the free fall;
(c) measuring (23) the change in height of the free fall by the fall detector;
(d) calculating (24) a difference between the calculated change in height and the measured change in height; and
(e) updating (25) a threshold in the fall detector for determining whether or not a fall has occurred on a basis of said difference.

2. A method as claimed in claim 1, further comprising a step of repeating steps (a) to (d) in order to obtain an averaged difference for use in step (e).

3. A method as claimed in claim 1, further comprising the steps of:
acquiring weather parameters reflecting a current environmental situation;
comparing the acquired parameters with weather parameters stored in advance in the fall detector to determine whether there is a change in the environment that is outside a predefined scope, the stored weather parameters reflecting the environmental conditions under which a previous calibration of the fall detector was carried out;
generating a request for calibrating the fall detector if the result of the comparison indicates that the change in environment is outside the predefined scope.

4. A method as claimed in claim 3, wherein the weather parameters comprise any one of air-pressure, temperature, humidity, wind power, and wind speed.

5. A method of setting a fall detector, comprising the steps of:
acquiring (41) the duration of a free fall of the fall detector performed from the height at which a user intends to wear the fall detector;
calculating (42) from said duration the change in height of the fall detector during the free fall; and
setting (43) the threshold in the fall detector for determining whether or not a fall has occurred on the basis of said calculated change in height.

6. A method as claimed in claim 5, further comprising the steps of:
determining the body posture of the user of the fall detector; and
setting the threshold on the basis of the body posture thus determined.

7. An apparatus for calibrating a fall detector, comprising:
a first acquiring unit (31) configured to acquire duration of a free fall of the fall detector;
a first calculator (32) configured to calculate from said duration a change in height of the fall detector during the free fall;
a second calculator (33) configured to calculate a difference between the calculated change in height and the change in height of the free fall measured by the fall detector; and
a updating unit (34) configured to update a threshold in the fall detector for determining whether or not a fall has occurred on a basis of said difference.

8. An apparatus as claimed in claim 7, further comprising:
a memory configured to store an averaged difference obtained by averaging the differences calculated several times by the second unit (33),
wherein the updating unit (34) is further configured to update the threshold with the averaged difference.

9. An apparatus as claimed in claim 7, further comprising:
a second acquiring unit configured to acquire weather parameters that reflect a current environmental situation;
a determining unit configured to compare the acquired parameters with weather parameters stored in advance in the fall detector to determine whether there is a change in environment that is outside a predefined scope, the stored weather parameters reflecting the environmental conditions under which a previous calibration of the fall detector was carried out; and
a generating unit configured to generate a request for calibrating the fall detector if the result of the comparison indicates that the change of environment is outside the predefined scope.

10. An apparatus as claimed in claim 7, wherein the unit (31) acquires the duration of a free fall of the fall detector taking place from a height at which a user intends to wear the fall detector, and the unit (32) calculates the change in height of the fall detector during the free fall from said duration, wherein the apparatus further comprises a setting unit (53) configured to set the threshold on the basis of the calculated change in height.

11. A fall detector, comprising:
an apparatus as claimed in claim 7.
